(19) United States
(12) Patent Application Publication
(10) Pub. No.: US 2005/0203780 A1
(43) Pub. Date: Sep. 15, 2005

(54) Method and apparatus for identifying uninsured motorists

(76) Inventor: Evan Lott, Salt Lake City, UT (US)

Correspondence Address: TRASK BRITT, P.O. BOX 2550, SALT LAKE CITY, UT, 84110, US

(21) Appl. No.: 11/073,011

(22) Filed: Mar. 4, 2005

Related U.S. Application Data
(63) Continuation of application No. 09/473,702, filed on Dec. 29, 1999.

(51) Int. Cl. G06F 17/60

(52) U.S. Cl. 705/4

(57) ABSTRACT

A method and apparatus for generating lists of uninsured motorists comprising: inputting into a computer processor a database of insurance, driver, and vehicle information; inputting into the computer processor a matching program; and computer translating and generating a list of uninsured motorists within a geographical area.

### CROSS-REFERENCE TO RELATED APPLICATIONS

This application is a continuation of application Ser. No. 09/473,702, filed Dec. 29, 1999, pending.

### BACKGROUND OF THE INVENTION

1. Field

This invention relates to methods for identifying uninsured motorists. More particularly, it relates to a method and apparatus to identify uninsured motorists within a geographical region with a high degree of statistical accuracy.

2. State of the Art

A number of computer programs exist that attempt to assist in identifying uninsured motorists. However, these programs do not generate matches to 96% of insurance polices written (one record for every vehicle per driver policy) at least monthly, with an accuracy rate exceeding 99%. Nor do they employ statistical surveys to update and check the insurance databases to increase their reliability. The method and apparatus described below provide such an invention.

### BRIEF SUMMARY OF THE INVENTION

The invention comprises a method and apparatus to prepare uninsured motorist lists and reports complete with vehicle identification numbers, names, and addresses of uninsured drivers. It also sends out notices advising uninsured drivers to acquire state mandated insurance. The apparatus employs a computer processor to cross-index insurance coverage with vehicles and drivers using up to fourteen different algorithms to insure that at least 95% are accurately matched.

### Databases

The databases inputted into the computer processor are:
a. “Insurance Information” from all reporting insurance carriers within a geographical area of all in-force policies. This information is inputted monthly, and contains the full name of the insured, their mailing address, driver's license number, date of birth, the insurance policy number, the policy effective date, make of vehicle, year of the vehicle, type of the vehicle and vehicle identification number.
b. “Driver Information” from the licensing division within a geographical area containing each driver's full name, their license number, address, and date of birth.
c. “Vehicle Information” from the division of motor vehicles within a geographical area containing the full name of the owner, their mailing address, the vehicle identification number, and make and year of the vehicle.

The above data is received in a variety of media types, including, but not restricted to, tapes, cartridges, discs, etc., and is integrated with a data integration system to include all relevant data. Insurance data is received containing an entry for every driver covered by an insurance policy on every vehicle. This results in multiple entries for automobiles driven by more than one driver. Because the raw data input function of this method and apparatus is capable of accepting data in a variety of formats, there is no need for extensive personnel training time as to the proper data fields and procedures.

In addition, the database inputs go through a testing process to check for errors and variances from similar data submitted for previous months. The incomplete data is then summarized into incomplete data reports, which are sent to the submitting entity. Most often these incomplete information reports are sent to submitting insurance companies with requests to provide the incomplete information, such as incomplete vehicle identification numbers (VINs), etc. It is important to note that even the incomplete data is entered into the system, fully processed, and later counted in the calculation of match and accuracy rates.

Direct matching comparisons of vehicle identification numbers, addresses, drivers, insurance information, etc., can only provide corresponding matches to approximately 70% of the database. This is because oftentimes VINs are incorrect, names and addresses are abbreviated or listed differently in the submittal data lists, or the format of the data is different—i.e., the owner of the vehicle may be listed as William Doe, and the insured may be listed as Bill Doe, while the driver may be listed as W. Doe. Similarly, the address of the owner of the vehicle may be listed as 10 South, the insured may be listed as living at Ten So., and the driver may be listed as living at 10 S. A heuristic matching program must therefore be employed to try several different methods of solving the matching problems inherent with dissimilar databases via computer subroutines and judge whether the program is closer to solutions after each attempt. The quantity of matches must correspond to approximately 96% of all insurance records available. Next the quality of the computer matches identified by the computer is checked to insure that the matches correspond to approximately 99%, resulting in an overall effective match rate of 95.8% of one driver per vehicle per policy.

### Methodology

The method is comprised of first compiling, and inputting the databases of insurance driver and vehicle information into a computer processor. A matching program is then inputted into the computer processor to thoroughly and systematically join driver, vehicle, and insurance policy data into a working database of uninsured motorists. To insure the accuracy of the database, statistical sampling and verification of the data provided is periodically performed. The computer processor then generates a real time series of reports to the state or geographic insurance and driver and vehicle regulatory agencies listing all of the uninsured motorists.

In addition, the computer processor generates and sends field-testing survey notices to the uninsured motorist asking for evidence of insurance. Based on the replies, the working database is then updated.

### Apparatus

To perform the method, the apparatus comprises a computer processor associated with a memory storage system. Inputted into the memory storage system are motor vehicle, motorist, and insurance information, and a heuristic computer matching program. The computer matching program then matches data by various categories and algorithms to identify uninsured motorists. A printer, display monitor, magnetic media device or electronic network controlled by the computer processor then outputs records of uninsured motorists, or other desired reports.

The insurance, motorist, and vehicle database information is preferably entered into the computer via software or by discs, magnetic tape strips, etc. However, manual inputting is also possible, where the information is not very large. After the generation of the uninsured motorist working database, random sampling and follow-up is generally conducted to verify the accuracy of the database. If significant errors are detected, appropriate adjustments to the data entry, gathering and processing systems are made. Thus the method provides a high degree of statistical accuracy of the lists of all uninsured motorists in a geographical region.

The above method and apparatus thus provides a simple means of identifying uninsured motorists and creating reports. These reports can be sent electronically to motorist regulatory agencies. It substantially reduces the uninsured motorist problems by providing law enforcement officers with the information they need to enforce the laws requiring motorist insurance coverage.

The invention is important and necessary because of the thousands of uninsured motorists violating the laws requiring financial responsibility in a state or geographic region. For example, law enforcement personnel, with computer access to live, up-to-date, uninsured motorist information, can ticket uninsured motorists without concern about record keeping mistakes. Manually performing this record keeping task is not only very time consuming, it is also not timely due to the requirement of hard copy updates and distribution delays. It is estimated that the present method and invention will reduce the number of uninsured motorists within a geographical area by more than 50%; resulting in substantial societal uninsured accident savings as well as easier record keeping.

The method also results in the preparation of more accurate uninsured motorist lists. Without accurate uninsured motorist lists, private insurance carriers may have their insured motorists unnecessarily interfered with by law enforcement agencies. The invention thus provides a public relations tool, which will assist insurers in protecting their policyholders from regulatory compliance hassles. However, its most important function is to insure that motorist coverage is available to fund accident recovery.

The invention also helps prevent audit delays and liability. Both public and private insurers currently conduct their own audit programs to verify that motorists are insured. This comprehensive insurance audit program significantly reduces the need for these independent public and private audits. It also provides insurance information to courtrooms for accurate insurance information status.

The notice procedures to inform uninsured motorists of their lack of coverage also enables those willing to comply with state law requirements the opportunity to acquire insurance to avoid enforcement actions.

### BRIEF DESCRIPTION OF THE SEVERAL VIEWS OF THE DRAWINGS

FIG. 1 illustrates a schematic flow diagram of a preferred method and apparatus.

FIG. 2 illustrates an incomplete data report.

FIG. 3 illustrates a sample registration screen.

FIG. 4 illustrates an insurance history look up screen.

FIG. 5. is an example of an uninsured motorist survey.

FIG. 6 is an example of an uninsured profile report.

FIG. 7 illustrates schematic flow diagram of a preferred configuration of the apparatus.

### DETAILED DESCRIPTION OF THE INVENTION

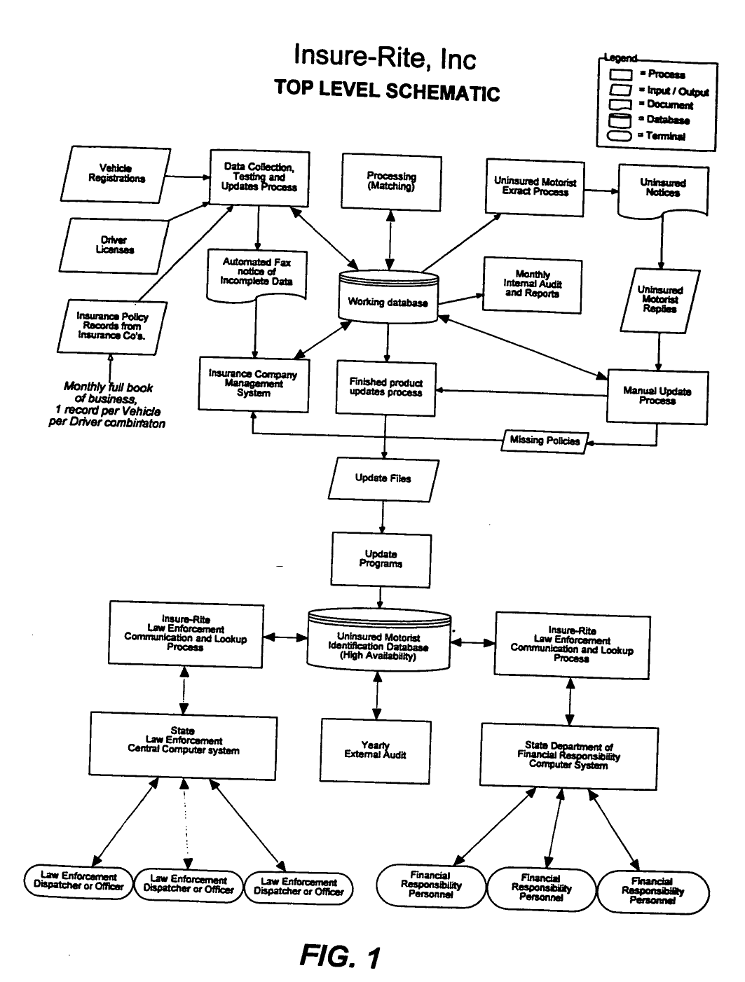

FIG. 1 illustrates a schematic flow diagram of the basic preferred overall method and apparatus. The first phase comprises inputting relevant vehicle registrations, drivers license information, and insurance policy records into a computer database. This information is then tested. Reports of incomplete data are then sent to the insurance carrier, or regulatory agency requesting correction of incomplete data problems in the future. The computer then joins insurance data to vehicle and driver data by employing a heuristic program as described above to insure that 96% of all insurance records are matched to vehicle and driver records.

From the uninsured motorist extraction process, notices are sent to the uninsured motorists asking them to verify their insurance coverage status. From the uninsured motorist replies, the working database is then manually updated to insure its reliability, forming the finished product: an updated motorist insurance status database.

In addition, the working database is monthly audited and statistically sampled to insure its reliability. Generally, this process produces monthly internal audit reports.

The updated files are then computer processed with a sorting format program to provide an uninsured motorist identification database in the format required by the appropriate regulatory agencies. This uninsured motorist database may then be periodically audited by the outside regulatory agencies to verify its reliability and accuracy.

The second phase allows the uninsured motorist identification database to be accessed directly on-line by secure remote terminals to provide law enforcement personnel and other state regulatory agencies with motorist insurance status. In addition, periodic trend reports are provided to various state agencies responsible for enforcement of the insured motorist laws to aid them in formulating policy and monitoring enforcement.

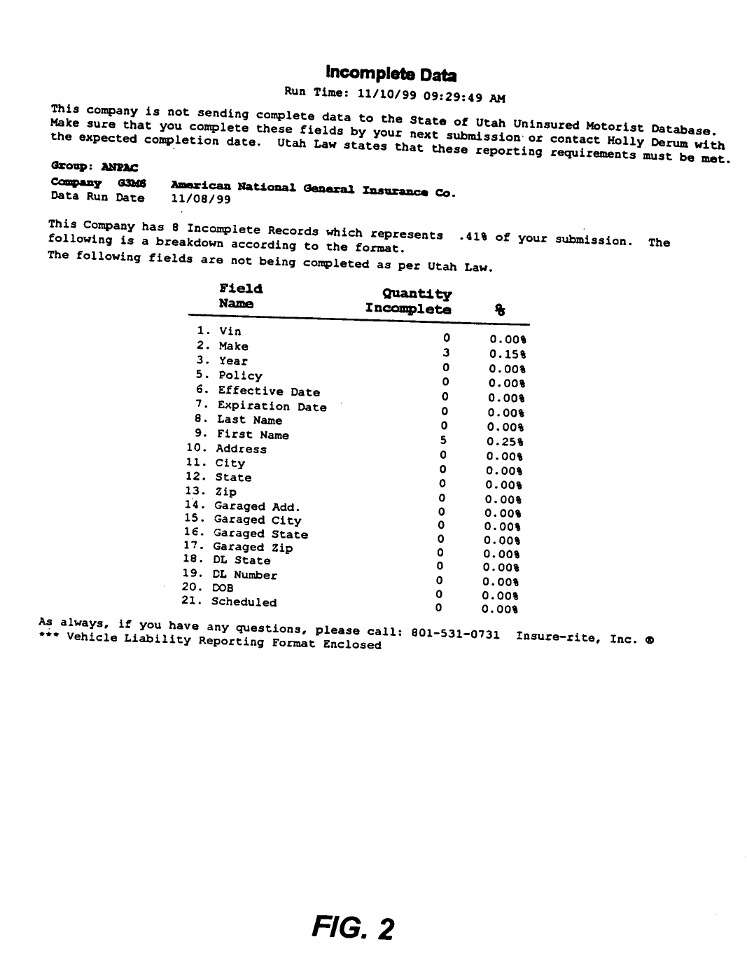

FIG. 2 illustrates an example of an incomplete data report sent to an insurance company showing the quantity of each incomplete data element.

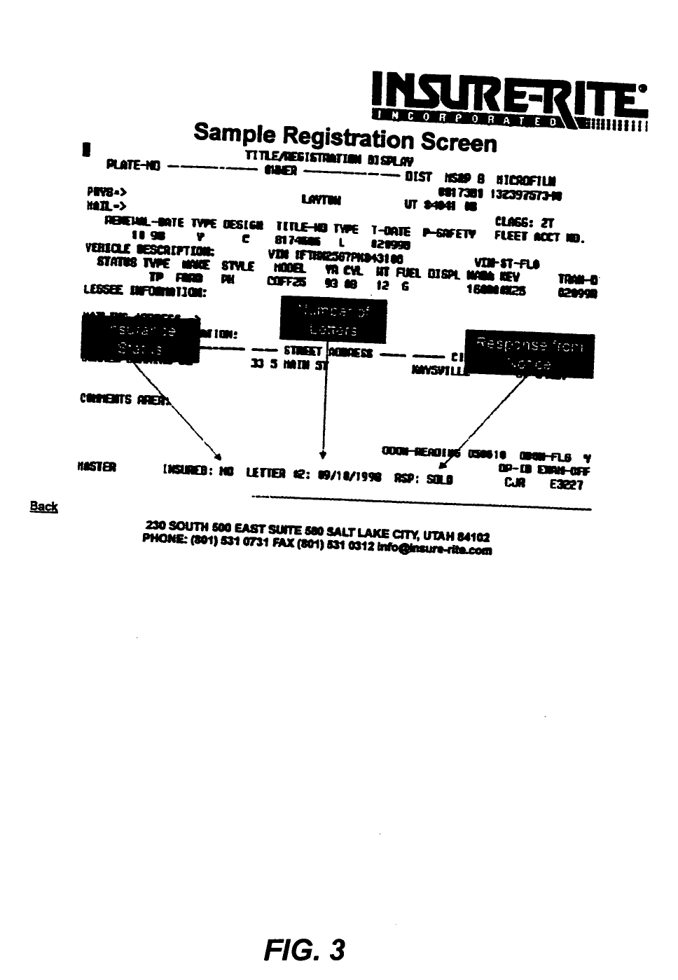

FIG. 3 illustrates a sample registration screen of a remote terminal providing the insurance status by owner and vehicle to vehicle registration and law enforcement personnel.

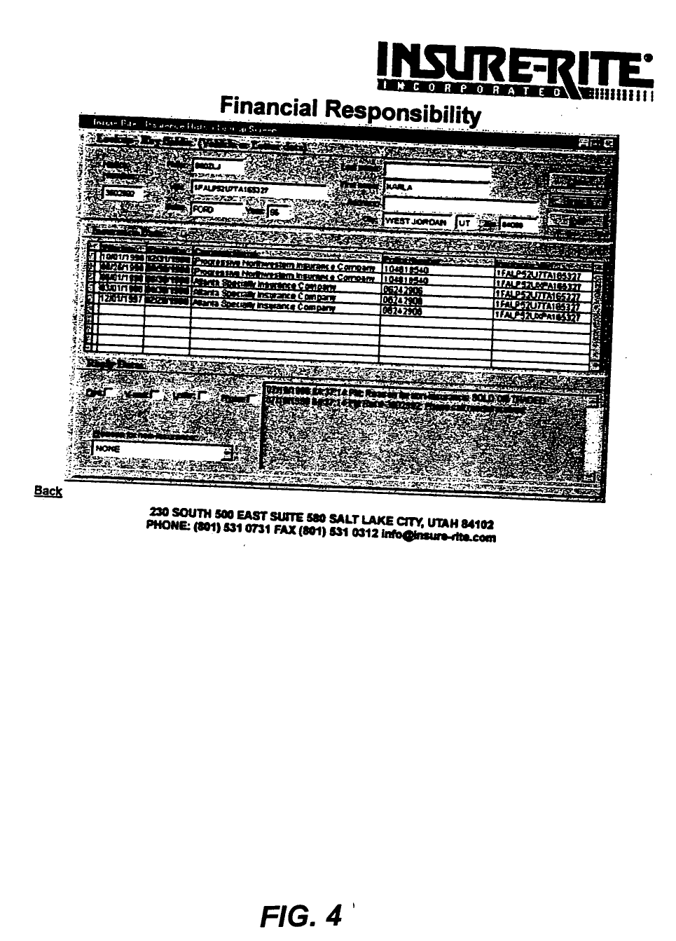

FIG. 4 illustrates an insurance history look up screen of a remote terminal providing information to authorized personnel by license plate, vehicle identification number, and driver's name regarding the insurance status of an individual or vehicle.

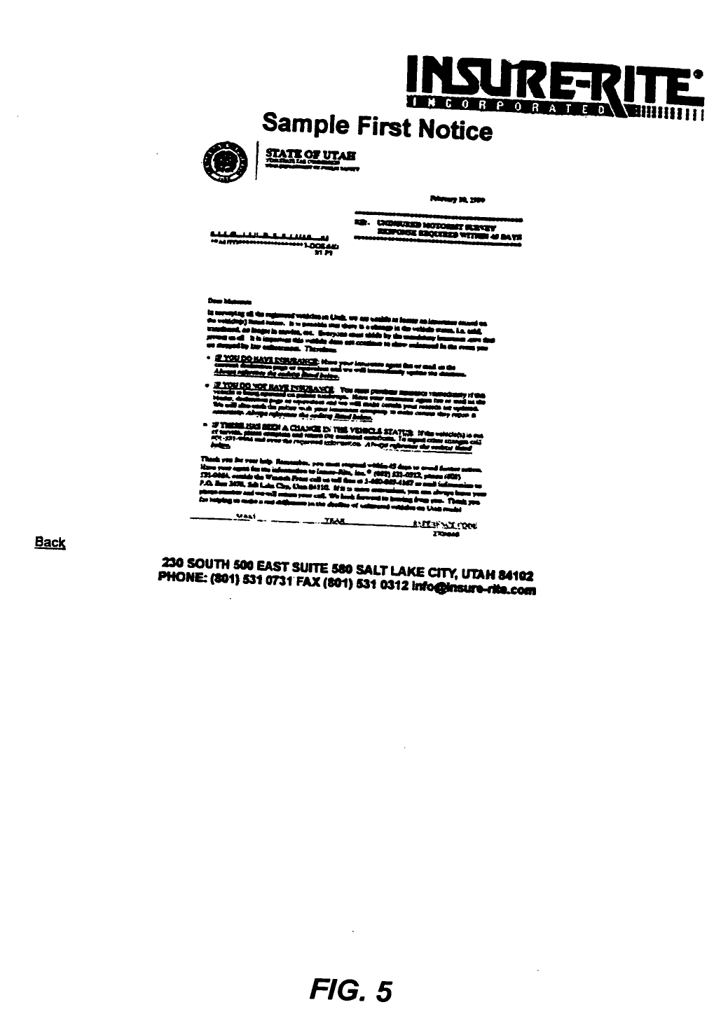

FIG. 5 is an example of a notice to uninsured motorist survey sent to individuals identified as not having current insurance in effect. Based on the replies to these notices, the uninsured motorist identification database is then updated.

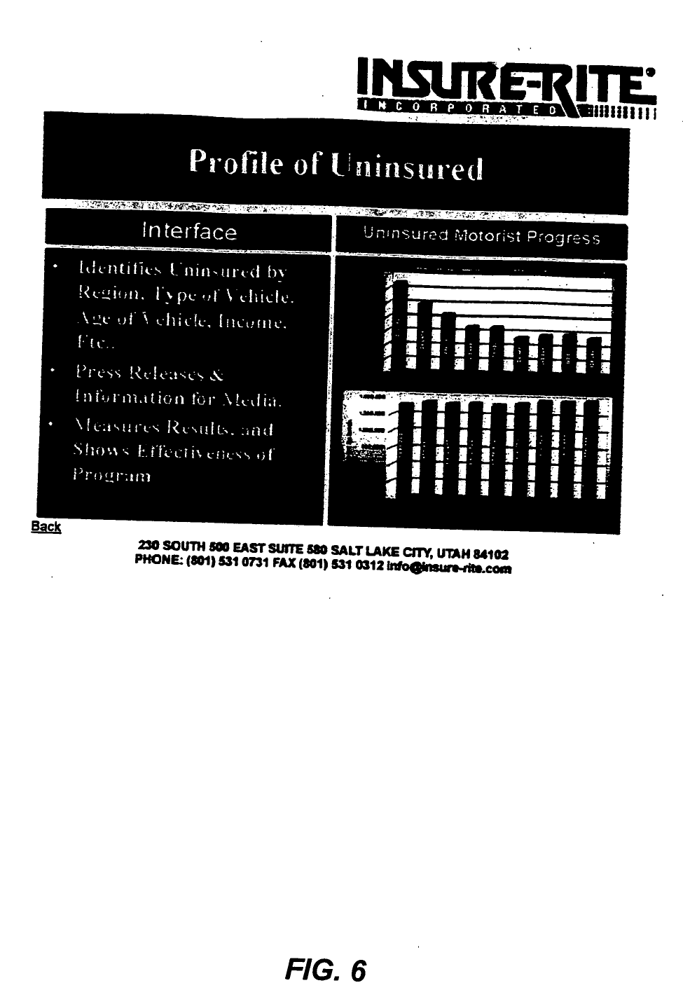

FIG. 6 is an example of an uninsured motorist trend profile submitted to those authorities responsible for administering a state's motor vehicle mandatory insurance laws and regulations. These trend reports enable administrators to adjust policies and enforcement procedures.

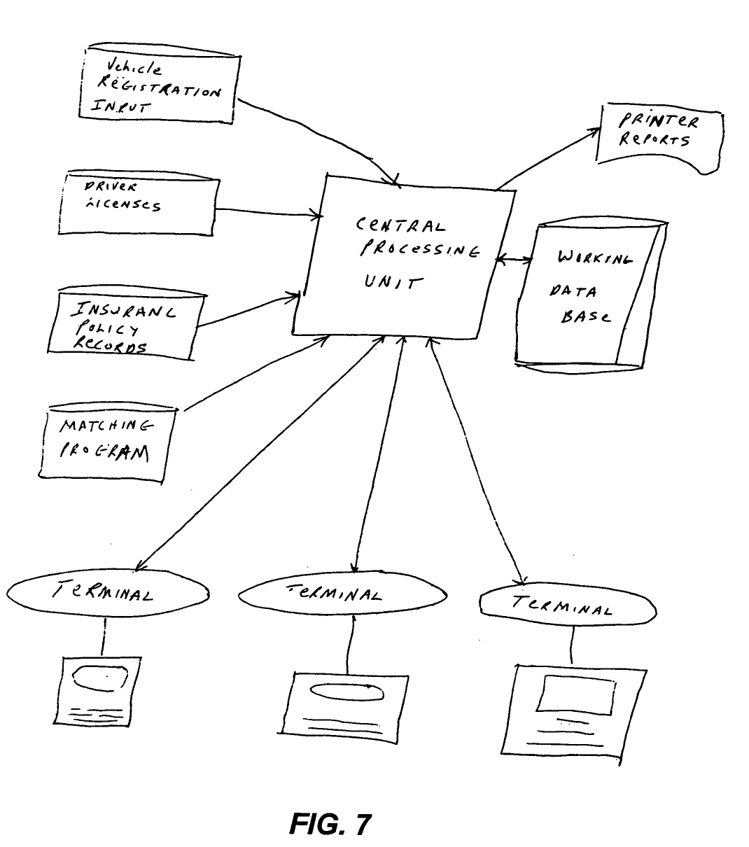

FIG. 7 illustrates schematic flow diagram of a simpler configuration of the apparatus used to compute, translate and generate the working database for use and review. A computer processor, such as a personal computer 10, is operationally associated and connected to input means 12, such as a disc reader or keyboard (not shown), a display terminal 14, and a printer 16. The system apparatus is loaded with various databases including motor vehicle, insurance, and driver information, and a heuristic sorting and matching program, which matches, and periodically tests the data before generating the uninsured motorist database.

The personal computer 10 then activates the computer terminal display 14 to display the insurance status for a given vehicle or driver for review. The personal computer 10 may then activate a printer 16 to print a list of uninsured motorists, or causes the information to be electronically transmitted to designated regulatory agency, court, or law enforcement personnel.

The configuration of the data output of the method and apparatus is adjusted to provide the informational data and reports required to enforce and administer the particular needs of a geographic region's uninsured motorist laws. However, all configurations employ a heuristic program to insure the high degree of accuracy and statistically reliability of the uninsured motorist lists.

Although the foregoing specification refers to the illustrated embodiments, it is not intended to restrict the scope of the appended claims. The claims themselves recite those features deemed essential to the invention.

1. An on-going method for identifying uninsured motorists on a periodic basis comprising:
a. initially inputting into a computer processor a database of all in-force insurance policies from all insurance carriers within a geographical area, including data such as name of the insured, their mailing addresses, driver's license numbers, dates of birth, policy numbers and effective dates, make of vehicle, year of vehicle, type of vehicle, and vehicle identification number,
b. inputting into a computer processor a database of all relevant driver information from the motorist licensing division within a geographical area such as a driver's full name, their license number, address, date of birth,
c. inputting into the computer processor a database of all relevant vehicle information from the division of motor vehicles within a geographical area such as the full name of the owner, mailing address, vehicle identification number, make and year of the vehicle, and other relevant information,
d. computer processing the databases by heuristic matching of non-corresponding sequences to generate a working database of uninsured motorists to a pre-determined high degree of reliability,
e. periodically inputting all current information identified in steps a), b), and c), and
f. repeating steps c) and d) to reduce and generate an updated working base of uninsured motorists.

2. The method of claim 1 wherein all relevant information includes incomplete and/or inaccurate information.

3. A method for identifying uninsured motorists according to claim 1, wherein the quantity of matches is at least 96%, and the quality of computer matches is at least 99% to provide an overall system reliability of 95.8% of matching drivers/vehicle/policy.

4. A method for identifying uninsured motorists according to claim 1, including computer generating notices of incomplete data and transmitting the same to the source submitting the incomplete data.

5. A method for identifying uninsured motorists according to claim 1, including statistically sampling the working database by selecting and verifying random samples of motorists to insure the statistical accuracy of the working database.

6. A method for identifying uninsured motorists according to claim 1, including generating lists of uninsured motorists.

7. A method for identifying uninsured motorists according to claim 1, including providing online real time computer display access to authorized personnel of the working database of uninsured motorists.

8. A method for identifying uninsured motorists according to claim 1, including mailing notices requesting insurance verification to uninsured motorists and inputting and updating the working database with the uninsured motorists replies to the notices.

9. A method for identifying uninsured motorists according to claim 1, including computer generating and transmitting trend report summaries of the status of uninsured motorists within a geographical area to concerned public and private agencies.

10. A method for identifying uninsured motorists on a periodic basis comprising:
a. inputting into a computer processor a database of all relevant insurance information from all insurance carriers within a geographical area of all in-force policies such as the name of the insured, their mailing addresses, driver's license numbers, dates of birth, policy numbers and effective dates, make of vehicle, year of vehicle, type of vehicle, and vehicle identification number,
b. inputting into a computer processor a database of all relevant driver information from the motorist licensing division within a geographical area such as a driver's full name, their license number, address, date of birth,
c. inputting into the computer processor a database of all relevant vehicle information for the division of motor vehicles within a geographical area such as the full name of the owner, their mailing address, vehicle identification number, make and year of the vehicle,
d. computer processing the databases by heuristic matching of non-corresponding sequences to generate a working database of uninsured motorists to a pre-determined high degree of reliability,
e. computer processor sorting and matching the insurance, driver, and vehicle databases to produce and generate a working database of uninsured motorists,
f. statistically sampling the working database by checking a random sample to insure the statistical accuracy of the working database,
g. generating lists of uninsured motorists,
h. providing on line real time computer display access to authorized personnel of the working database of uninsured motorists,
i. mailing notices requesting insurance verification to uninsured motorists and inputting and updating the working database with the uninsured motorists replies to the notices,
j. computer generating and transmitting trend report summaries of the status of uninsured motorists within a geographical area to concerned public and private agencies, and
k. periodically repeating steps a) through j).

11. An apparatus for identifying uninsured motorists comprising:
a. input means,
b. storage means into which a database of
i. all relevant insurance information from all insurance carriers within a geographical area of all in-force policies such as the name of the insured, their mailing addresses, driver's license numbers, dates of birth, policy numbers and effective dates, make of vehicle, year of vehicle, type of vehicle, and vehicle identification number,
ii. all relevant driver information from the motorist licensing division within a geographical area such as the driver's full name, their license number, address, date of birth,
iii. all relevant vehicle information for the division of motor vehicles within a geographical area such as the full name of the owner, their mailing address, vehicle identification number, make and year of the vehicle,
iv. a sorting and matching program to computer process the databases by heuristic matching of non-corresponding sequences to generate a working database of uninsured motorists to a pre-determined high degree of statistical reliability,
c. a computer processor operably associated with the input means and storage means to translate and generate lists of uninsured motorists within a geographical area, and
d. a display terminal operably associated with and activated by the computer processor unit to display lists of uninsured motorists.

12. An apparatus for listing uninsured motorists according to claim 10, including electronic signal transfer means to transmit coded electronic signals to a receiving translator, which converts the coded electronic signals into printed reports for interested public and private agencies.
